(19) United States
(12) Patent Application Publication
(10) Pub. No.: US 2012/0111108 A1
(43) Pub. Date: May 10, 2012

(54) LIQUID LEVEL DETECTING DEVICE

(75) Inventors: Hiroshi Hashimoto, Obu-city (JP); Yoshifumi Terada, Toyota-city (JP)

(73) Assignee: DENSO CORPORATION, Kariya-city (JP)

(21) Appl. No.: 13/290,215

(22) Filed: Nov. 7, 2011

(30) Foreign Application Priority Data
Nov. 8, 2010 (JP) 2010-250083
Jun. 24, 2011 (JP) 2011-141108

(51) Int. Cl. G01F 23/36

(52) U.S. Cl. 73/317

(57) ABSTRACT

One end of a float arm is connected to a float and the other end thereof is rotatably supported by a housing made of insulating resin material. An electrically conductive portion, which is for example made of conducting resin material, is integrally formed with the housing and electrically connecting the other end of the float arm to a ground terminal which is fixed to the housing. A detecting circuit is accommodated in the housing. Electric charge generated at the float due to friction between the float and fuel is grounded to the earth via the float arm, the electrically conductive portion and the ground terminal, so that an adverse effect of the electric charge to the detecting circuit can be avoided.

### CROSS REFERENCE TO RELATED APPLICATION

This application is based on Japanese Patent Application No. 2010-250083 filed on Nov. 8, 2010 and No. 2011-141108 filed on Jun. 24, 2011, the disclosures of which are incorporated herein by reference.

### FIELD OF THE INVENTION

The present invention relates to a liquid level detecting device for detecting a liquid surface level of a liquid stored in a container.

### BACKGROUND OF THE INVENTION

A liquid level detecting device is known in the art, in which a liquid surface level is detected by a float floating on the liquid surface. According to a structure of the liquid level detecting device of this kind, for example, as disclosed in patent publications listed below, the liquid level detecting device has a main body portion fixed to a liquid container, an arm holder pivotally attached to the main body portion, and a float arm holding a float and pivotally supported by the main body portion:
(1) Japanese Patent No. 3,941,735,
(2) U.S. Pat. No. 7,591,178,
(3) U.S. Pat. No. 6,877,373,
(4) U.S. Pat. No. 7,089,918.

The above liquid level detecting device further has an electric resistive element, a value of electric resistance of which varies depending on a rotational angle of the arm holder. According to the above liquid level detecting device, a vertical movement of the float is converted into a rotational movement by the float arm and the rotational movement is transmitted to the arm holder. The value of the electric resistance of the electric resistive element, which varies depending on the rotational angle of the arm holder, is measured so as to detect the liquid surface level.

In the liquid level detecting device of the above patent Publications (1) to (4), in which the float is used for detecting the liquid surface level, electric charge is generated at the float due to friction between the float and the liquid. When a large amount of electric charge is accumulated at the float and the float arm, and then such accumulated electric charge is discharged to the electric resistive element, the detection of the liquid surface level may be adversely affected.

According to the liquid level detecting device, for example, as disclosed in the above patent Publications (1) and (2), the arm holder is made of conducting material in order to suppress the above mentioned discharge. On the other hand, according to the liquid level detecting device disclosed in the above patent Publications (3) and (4), an electrically conductive member, which connects the float arm and the electric resistive element, is provided at the arm holder. According to the above structures, the large amount of the electric charge may not be accumulated and the electric charge is released to the electric resistive element.

According to the liquid level detecting device, the large amount of the electric charge may not be accumulated due to the discharge. However, the electric charge generated by the friction between the float floating on the liquid surface and the liquid flows to the electric resistive element from time to time via the float arm and the arm holder. Therefore, when the electric charge generated by the friction between the float and the liquid flows into a variable resister, the electric charge may affect to the detection of the liquid surface level as a noise. As a result, the detection of the liquid surface level by the electric resistive element may be still adversely affected. Accordingly, it may not be possible to exactly detect the liquid surface level.

### SUMMARY OF THE INVENTION

The present invention is made in view of the above problems. It is an object of the present invention to provide a liquid level detecting device, according to which the liquid surface level is exactly detected.

According to a feature of the invention, a liquid level detecting device detects a level of liquid surface of liquid stored in a container. The liquid level detecting device has a stationary member fixed to the container, a rotating member rotatably supported by the stationary member, and a float floating on the liquid surface of the liquid. The device further has a float arm, one end of which holds the float and the other end of which is rotatably supported by the stationary member, wherein the float arm has conducting properties and converts a vertical movement of the float into a rotational movement of the rotating member. The device further has a detecting portion fixed to the stationary member and having a variable resister, a value of electric resistance of which varies depending on a rotational angle of the rotating member, wherein the detecting portion detects the level of the liquid surface based on the value of electric resistance of the variable resister. The device further has a ground terminal for electrically connecting the detecting portion to an outside of the liquid level detecting device so that the detecting portion is grounded, and an electrically conductive portion for electrically connecting the float arm to the ground terminal.

According to the above feature, the electric charge generated by the friction between the float floating on the liquid surface and the fuel is moved to one end of the float arm, which holds the float and is formed of the conducting material. The float arm is electrically connected to the ground terminal via the electrically conductive portion, wherein the ground terminal is grounded to the outside of the liquid level detecting device. Accordingly, the electric charge moved to the float arm is grounded to the earth via the electrically conductive portion and the ground terminal. As a result, the electric charge hardly flows into the variable resister (the value of the electric resistance of which varies depending on the rotational angle of the rotating member) via the rotating member supporting the float arm. It is, therefore, possible to avoid such a situation in which the electric charge generated between the float and the liquid flows into the variable resister as electric noise. The liquid level detecting device is realized, according to which the level of the liquid surface can be exactly detected.

### BRIEF DESCRIPTION OF THE DRAWINGS

The above and other objects, features and advantages of the present invention will become more apparent from the following detailed description made with reference to the accompanying drawings. In the drawings:

FIG. 1A is a schematic front view showing a fuel gauge according to a first embodiment of the present invention;

FIG. 1B is an enlarged front view of a relevant portion of the fuel gauge shown in FIG. 1A;

FIG. 2 is a schematic side view showing the fuel gauge of the first embodiment, when viewed in a direction II in FIG. 1A;

FIG. 3 is a schematic back view showing the fuel gauge of the first embodiment, when viewed in a direction III in FIG. 2;

FIG. 4 is a schematic cross sectional view taken along a line IV-IV in FIG. 3 for explaining an electrically conductive member, which is a characterizing portion of the present invention;

FIG. 5 is a schematic enlarged view of a portion indicated by V in FIG. 1B for explaining the electrically conductive member, which is the characterizing portion of the present invention;

FIG. 6 is a schematic cross sectional view taken along a line

VI-VI in FIG. 1B for explaining a characterizing portion of a fuel gauge according to a second embodiment of the present invention;

FIG. 7 is a schematic cross sectional view taken along a line VII-VII in FIG. 6;

FIG. 8 is a schematic back view showing a fuel gauge according to a third embodiment of the present invention, wherein the embodiment of FIG. 8 corresponds to a variation of FIG. 3;

FIG. 9 is a schematic cross sectional view taken along a line IX-IX in FIG. 8 for explaining a characterizing portion of the fuel gauge according to the third embodiment;

FIG. 10 is a schematic cross sectional view taken along a line X-X in FIG. 8 for explaining a characterizing portion of the fuel gauge according to the third embodiment;

FIG. 11 is a schematic cross sectional view showing a modification of FIG. 9, which is a fourth embodiment of the present invention;

FIG. 12 is a schematic cross sectional view showing a further modification of FIG. 9, which is a fifth embodiment of the present invention;

FIG. 13 is a schematic perspective view showing a fuel gauge according to a sixth embodiment of the present invention;

FIG. 14A is a schematic front view showing a housing of the sixth embodiment and FIG. 14B is a schematic front view showing a part of an electrically conductive member indicated by a dotted line in FIG. 14A;

FIG. 15A is a schematic side view showing the housing of the sixth embodiment and FIG. 15B is a schematic side view of the part indicated by a dotted line in FIG. 15A;

FIG. 16 is a schematic perspective view showing the electrically conductive member, which is a characterizing portion of the present invention; and

FIG. 17 is a schematic cross sectional view taken along a line XVII-XVII in FIG. 14A for explaining the electrically conductive member provided in a bottom wall of the housing.

### DETAILED DESCRIPTION OF THE PREFERRED EMBODIMENTS

The present invention will be explained by way of several embodiments with reference to drawings. The same reference numerals are used throughout the embodiments for the same or similar parts and/or portions, so that repeated explanation thereof will be omitted. The embodiments may be combined with each other, unless such combination may cause an adverse effect.

### First Embodiment

A liquid level detecting device according to a first embodiment of the present invention, which is applied to a fuel gauge 100 for detecting a level of a liquid surface 91a of fuel 91 stored in a fuel tank 90, will be explained. Information detected by the fuel gauge 100 is outputted to a combination meter (not shown) of a vehicle so that such information is displayed in the combination meter to a vehicle driver.

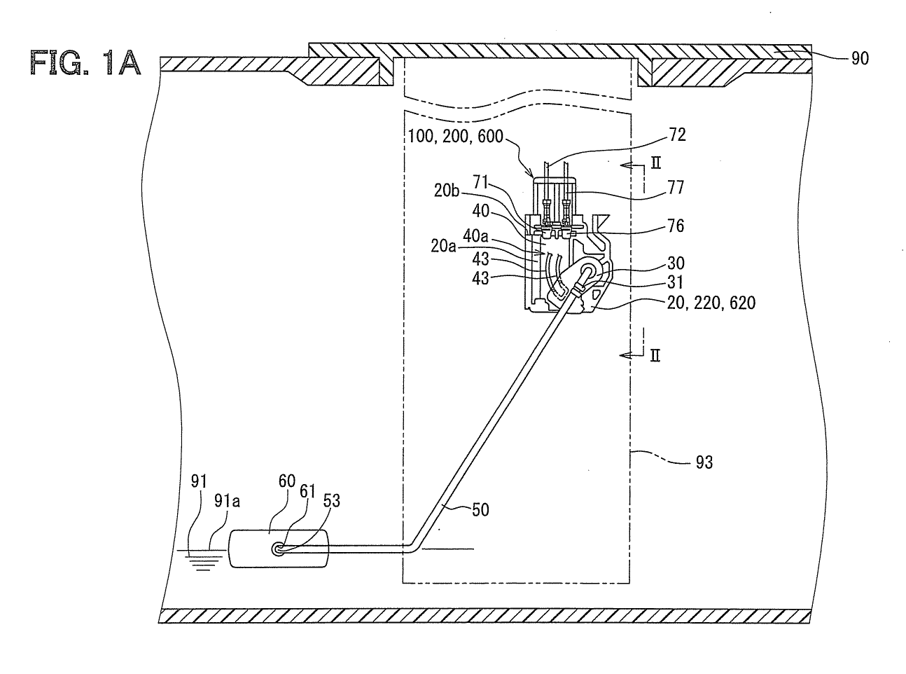

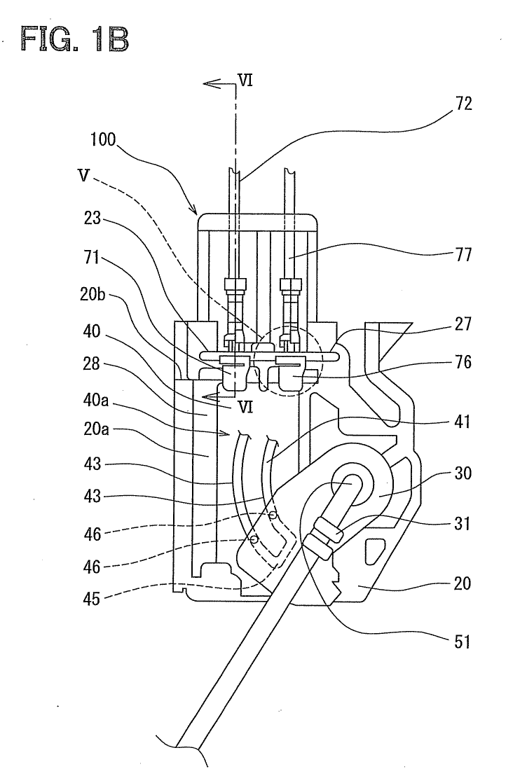

FIGS. 1A and 1B are respectively schematic front views showing the fuel gauge 100 according to the first embodiment of the present invention. As shown in FIG. 1A, the fuel gauge 100 is arranged in a container (the fuel tank 90). The fuel gauge 100 is attached to a side wall of a fuel pump module 93, which supplies the fuel 91 to an internal combustion engine. The fuel gauge 100 is fixed to the fuel tank 90 together with the fuel pump module 93. A method for fixing the fuel gauge 100 to the fuel tank 90 should not be limited to the above method. For example, the fuel gauge 100 may be directly fixed to an inside of the fuel tank 90 via a fixing stay (not shown).

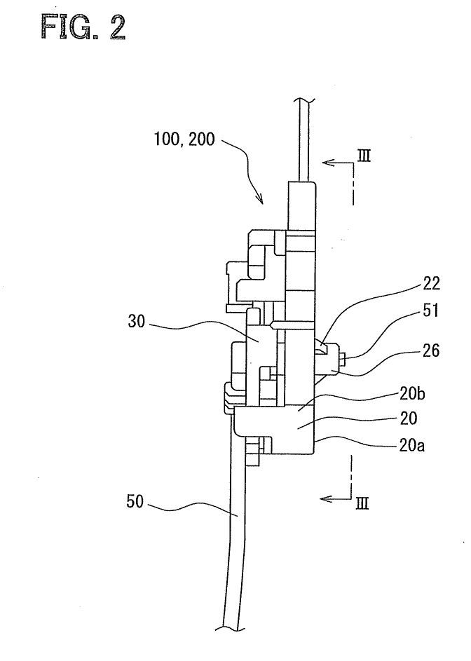

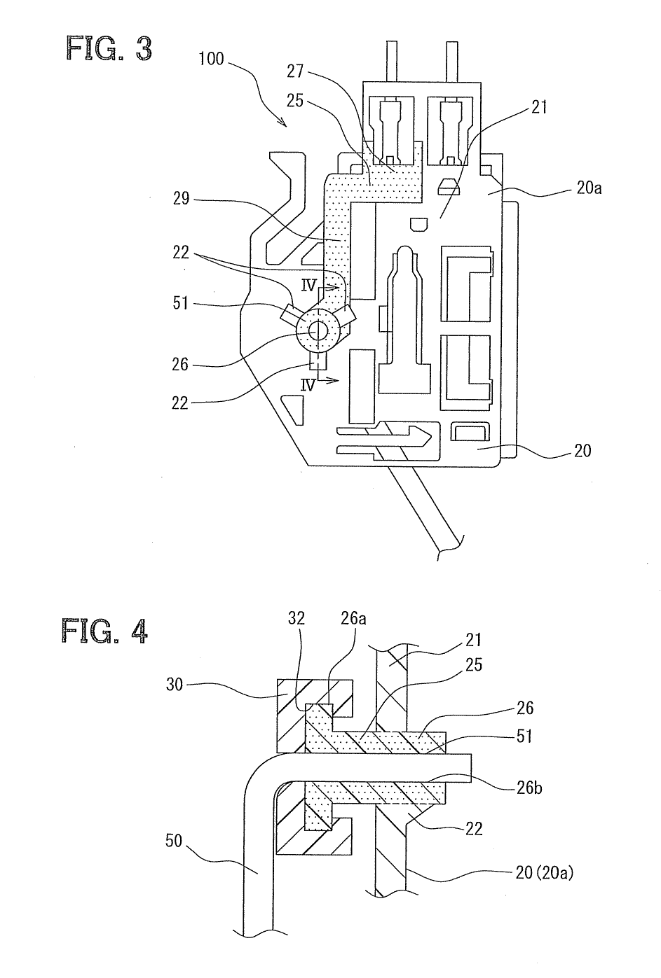

A basic structure of the fuel gauge 100 will be explained with reference FIGS. 1A to 3. FIG. 1B is an enlarged view of the fuel gauge 100 shown in FIG. 1A. FIG. 2 is a side view of the fuel gauge 100. FIG. 3 is a back view of the fuel gauge 100. The fuel gauge 100 is composed of a float 60, an arm holder 30, a float arm 50, a housing 20, a positive terminal 71, a ground terminal 76, and a printed circuit board 40 on which a detecting circuit 40a is formed.

The float 60 is made of such a material, which has a small specific gravity, for example, expanded ebonite. The float 60 is made of the material having smaller specific gravity than that of the fuel 91, so that the float 60 floats on the liquid surface 91a of the fuel 91. A through-hole 61 is formed in the float 60, so that the float 60 is connected to the float arm 50. The through-hole 61 is formed in the float 60 in such a manner that the through-hole 61 passes through a center of gravity of the float 60. A shape of the float 60 is formed in a rectangular solid. The float 60 may be formed in any other shapes, for example, in a shape of a cylinder solid.

The arm holder 30 (also referred to as a rotating member) is made of such a material, which is oil-proof and solvent-proof and which has a high mechanical property, for example, polyacetal (POM) resin. The arm holder 30 is formed in a plate shape. The arm holder 30 has a bearing surface 32 (FIG. 4) and an arm supporting portion 31 (FIG. 1B). The bearing surface 32 is an inner peripheral surface of a cylindrical hole extending in a thickness direction of the arm holder 30. As a result that the bearing surface 32 is attached to the housing 20, the arm holder 30 is rotatably supported by the housing 20. The arm supporting portion 31 fixes the float arm 50 to the arm holder 30, so that the arm holder 30 is integrally rotated with the float arm 50 relative to the housing 20.

The float arm 50 is made of electrically conducting metal, such as stainless steel, and formed in a shape of a round bar. A float holding portion 53 is formed at one end of the float arm 50. The float holding portion 53 is formed by bending the one end of the float arm 50 by 90 degrees in the same direction to a rotational axis of the arm holder 30. A rotational shaft 51 is formed at the other end of the float arm 50. The rotational shaft 51 is formed by bending the other end of the float arm 50 in the same direction to the rotational axis of the arm holder 30 toward the housing 20 by 90 degrees. The float arm 50 holds the float 60 at the one end thereof (namely, at the float holding portion 53), while the float arm 50 is rotatably supported by the housing 20 at the other end thereof by the rotational shaft 51. According to the above structure, the float arm 50 converts the vertical movement of the float 60 into the rotational movement of the arm holder 30.

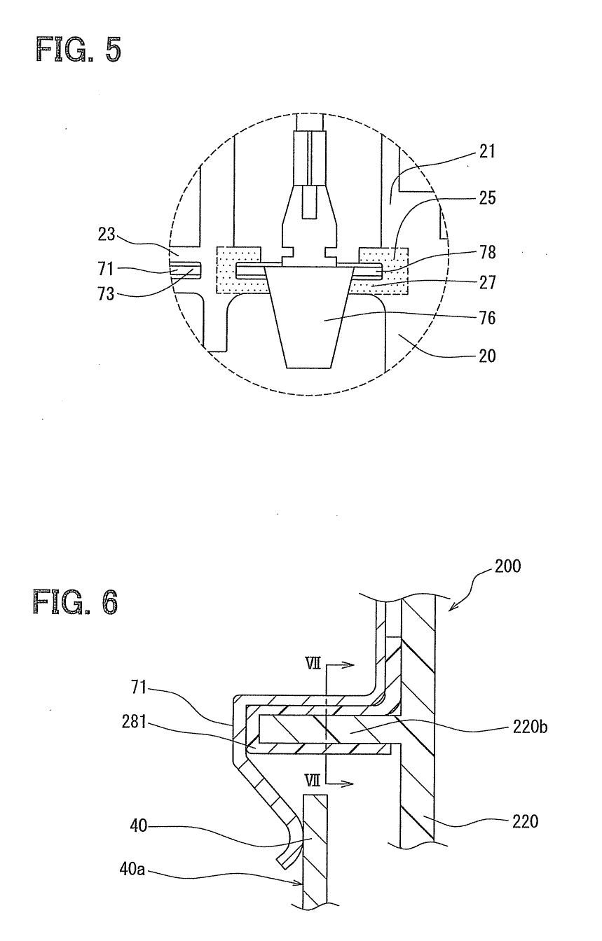

The housing 20 (also referred to as a stationary member) is attached to the fuel pump module 93 and fixed to the fuel tank 90 via the fuel pump module 93. The housing 20 has a bottom wall 20a extending along a wall surface of the fuel pump module 93 and a side wall 20b extending from an outer periphery of the bottom wall 20a in a direction opposite to the fuel pump module 93. The housing 20 has a main body portion 21, press-fit portions 23 and 27 (FIG. 5), a tubular portion 26 (also referred to as a bearing portion), and a board accommodating portion 28.

The main body portion 21 is made of insulating material, for example, POM resin. According to the present embodiment, the bottom wall 20a and the side wall 20b are basically formed by the main body portion 21. The press-fit portions 23 and 27 are formed in the side wall 20b. Each of the press-fit portions 23 and 27 has a hole formed in the side wall 20b extending in the same direction to the extending direction of the side wall 20b. The positive terminal 71 is inserted into the hole of the press-fit portion 23 in the extending direction of the side wall 20b. The positive terminal 71 is press-fitted into the press-fit portion 23, so that the positive terminal 71 is firmly fixed to the housing 20. The ground terminal 76 is likewise inserted into the hole of the press-fit portion 27 in the extending direction of the side wall 20b. The ground terminal 76 is press-fitted into the press-fit portion 27, so that the ground terminal 76 is firmly fixed to the housing 20.

The tubular portion 26 is formed in a cylindrical shape and provided at the bottom wall 20a. An axial direction of the tubular portion 26 provided in the bottom wall 20a is perpendicular to a plate direction of the bottom wall 20a. A circular flange 26a is formed at one end of the tubular portion 26. The circular flange 26a rotatably supports the bearing surface 32 of the arm holder 30 (FIG. 4). In addition, a bearing surface 26b formed at an inner surface of the tubular portion 26 rotatably supports the rotational shaft 51 of the float arm 50 (FIG. 4). The board accommodating portion 28 is a space surrounded by the bottom wall 20a and the side wall 20b. The printed circuit board 40 is accommodated in the board accommodating portion 28.

The positive terminal 71 has a positive-side wire 72 connected to the combination meter or the like. An outside of the fuel gauge 100 and the detecting circuit 40a are connected with each other by the wire 72, so that the positive terminal 71 supplies electric voltage to the detecting circuit 40a via the wire 72. The positive terminal 71 is made of conducting material, for example, cupper. The positive terminal 71 has a press-insert portion 73, which is inserted into the hole of the press-fit portion 23 (FIG. 5). A width of the press-insert portion 73, that is a dimension in a direction perpendicular to an inserting direction of the press-insert portion 73, is made slightly larger than an inner dimension of the hole of the press-fit portion 23. The press-insert portion 73 is press-inserted into the press-fit-portion 23, so that the press-insert portion 73 is firmly attached to the inner wall of the press-fit portion 23 by elastic force of the positive terminal 71. As above, the positive terminal 71 is firmly fixed to the press-fit portion 23.

The ground terminal 76 has a ground-side wire 77 connected to the combination meter or the like. The ground terminal 76 applies ground level voltage to the variable resister 41 via the ground-side wire 77. The ground terminal 71 is made of conducting material, for example, cupper, like the positive terminal 71. The ground terminal 76 has a press-insert portion 78, which is inserted into the hole of the press-fit portion 27 (FIG. 5). A width of the press-insert portion 78, that is a dimension in a direction perpendicular to an inserting direction of the press-insert portion 78, is made slightly larger than an inner dimension of the hole of the press-fit portion 27. The press-insert portion 78 is press-inserted into the press-fit-portion 27, so that the press-insert portion 78 is firmly attached to the inner wall of the press-fit portion 27 by elastic force of the ground terminal 76. As above, the ground terminal 76 is firmly fixed to the press-fit portion 27.

The printed circuit board 40 is accommodated in the board accommodating portion 28 of the housing 20, so that the printed circuit board 40 is held in the housing 20. The detecting circuit 40a is formed on the printed circuit board 40 for detecting a rotational angle of the arm holder 30. The detecting circuit 40a has the variable resister 41 in order to detect the rotational angle of the arm holder 30 and thereby the liquid surface level 91a based on the electric resistance value of the variable resister 41.

The variable resister 41 is composed of a sliding plate 45, a pair of resistive element patterns 43 and so on. The sliding plate 45 is made of metal in a shape of a plate. The sliding plate 45 is provided at a surface of the arm holder 30 facing to the printed circuit board 40. The sliding plate 45 rotates together with the arm holder 30. A pair of sliding contacts 46 is provided on the sliding plate 45. Each of the sliding contacts is biased toward the printed circuit board 40 by elastic force of the sliding plate 45.

The pair of the resistive element patterns 43 is provided on a surface of the printed circuit board 40 facing to the arm holder 30. Each of the resistive element patterns 43 is formed in an arc shape having a radius around a center of the rotational axis of the arm holder 30, so that the arc shape of the patterns coincides with circles of the sliding contacts 46 of the sliding plate 45, which is integrally rotated with the arm holder 30. One of the resistive element patterns 43 is connected to the positive terminal 71, while the other resistive element pattern 43 is connected to the ground terminal 76.

Each of the sliding contacts 46 is kept in contact with the resistive element patterns 43 by the elastic force of the sliding plate 45. When contacting points between the respective sliding contacts 46 of the sliding plate 45 (integrally rotated with the arm holder 30) and the respective resistive element patterns 43 are located at such positions, which are closest to the respective terminals 71 and 76, the electric resistance value of the variable resister 41 becomes a minimum value. When the arm holder 30 is rotated in a direction so that the contacting points are moved away from the above positions (namely, from the terminals 71 and 76), the electric resistance value of the variable resister 41 is gradually increased. When the arm holder 30 is further rotated in the above direction, the contacting points are moved to such positions, which are uttermost from the terminals 71 and 76. Then, the electric resistance value of the variable resister 41 becomes a maximum value. As above, the electric resistance value is changed depending on the rotational angle of the arm holder 30. Therefore, the combination meter, which is connected to the detecting circuit 40a via the terminals 71 and 76, can get voltage potential difference between the terminals 71 and 76 depending on the electric resistance value of the variable resister 41, as detected information for the liquid surface level 91a.

An electrically conductive member 25, which is one of characterizing portions of the fuel gauge 100 of the present embodiment, will be explained with reference to FIGS. 3 to 5. The electrically conductive member 25 is also referred to as an electrically conductive portion.

According to the present embodiment, the housing 20 is manufactured by a two-stage molding method. The housing 20 is composed of the main body portion 21 made of the insulating resin and the electrically conductive member 25, which is made of conducting resin and integrally formed with the main body portion 21. The resin for the electrically conductive member 25 is, for example, POM resin including about 5-percent carbon.

The electrically conductive member 25 is composed of the tubular portion 26, the press-fit portion 27 to which the ground terminal 76 is fixed, and a connecting portion 29. Since the tubular portion 26 rotatably supports the rotational shaft 51 of the float arm 50, the tubular portion 26 is surely in contact with the rotational shaft 51. Furthermore, since the ground terminal 76 is press-fitted into the press-fit portion 27, the press-fit portion 27 is surely in contact with the ground terminal 76. The connecting portion 29, which forms a part of the bottom of the housing 20 together with the bottom wall 20a thereof, electrically connects the tubular portion 26 and the press-fit portion 27 with each other.

According to the above structure, the electrically conductive member 25 electrically connects the float arm 50 and the ground terminal 76 with each other. According to the present embodiment, an electrical resistance value of the electrically conductive member 25 between the float arm 50 and the ground terminal 76 is adjusted at such a value smaller than 1 megohm (MΩ).

The main body portion 21 has multiple supporting ribs 22. Each of the ribs 22 is projected from the bottom wall 20a of the main body portion 21 along an axial direction of the tubular portion 26 toward a direction opposite to the arm holder 30. According to the present embodiment, three supporting ribs 22 are formed so as to surround an outer periphery of the tubular portion 26 at equal intervals in a circumferential direction. The multiple supporting ribs 22 are in contact with the tubular portion 26 in order to support it at an outer periphery thereof.

A manufacturing process (the two-stage molding method) for the housing 20 will be explained. The housing is manufactured by a process for forming the electrically conductive member 25 and a process for forming the main body portion 21. At a first process, the conducting resin is molten and filled in a resin molding die so as to form the electrically conductive member 25. At a second process, the electrically conductive member 25 manufactured in the above first process is set in another resin molding die. Then, the insulating resin is molten and such molten resin is filled into the resin molding die, so that the main body portion 21 which is integrally formed with the electrically conductive member 25 is manufactured.

According to the above explained embodiment, the electric charge generated by the friction between the float 60 floating on the liquid surface 91a and the fuel 91 moves to the float arm 50 made of the conducting material. The float arm 50 is electrically connected to the ground terminal 76 via the electrically conductive member 25. Therefore, the electric charge moved to the float arm 50 flows to the ground via the electrically conductive member 25 and the ground terminal 76. In other words, the electric charge hardly flows to the variable resister 41 via the arm holder 30, which supports the float arm 50. As above, it is possible to avoid such a situation, in which the electric charge generated by the friction between the float 60 and the fuel 91 may flow to the variable resister 41 as the noise and thereby the detection of the liquid surface level by the detecting circuit 40a may be adversely affected. Accordingly, the fuel gauge 100 can be realized, according to which the level of the liquid surface 91a can be exactly detected.

In addition, according to the above embodiment, in which the housing 20 is made of the insulating resin material, the electrically conductive member 25 which is made of the conducting resin material is integrally formed with the main body portion 21. When the electrically conductive member 25 is integrally formed with the main body portion 21, it is possible to suppress an increase of a number of parts and components for the fuel gauge 100 having the electrically conductive member 25. A number of manufacturing steps (a number of assembling processes) for the electrically conductive member 25 can be reduced. The fuel gauge 100, which can exactly detect the liquid surface level and which can be manufactured at a low cost, can be provided.

In the above embodiment, in which the electrically conductive member 25 is formed in the housing 20, the bearing surface 26b for rotatably supporting the float arm 50 is more preferably provided in the electrically conductive member 25 than the main body portion 21. As a result that the electrically conductive member 25 has the bearing surface 26b, the electrical connection between the float arm 50 and the electrically conductive member 25 is surely maintained via the bearing surface 26b supporting the rotational shaft 51, even when the float arm 50 is rotated depending on the vertical movement of the float 60. The electric charge accumulated in the float arm 50 can be, thereby, surely moved to the electrically conductive member 25 and grounded to the earth via the ground terminal 76. It is, therefore, possible to provide the fuel gauge 100 which can exactly detect the level of the liquid surface 91a.

Furthermore, as explained in the above embodiment, the press-fit portion 27 for connecting the ground terminal 76 is more preferably formed in the electrically conductive member 25 than the main body portion 21. As a result that the electrically conductive member 25 has the press-fit portion 27, the electrical connection between the ground terminal 27 and the electrically conductive member 25 is surely maintained via the press-fit portion 27. The electric charge moved to the electrically conductive member 25 via the float arm 50 can be, thereby, surely grounded to the earth via the ground terminal 76. It is, therefore, possible to provide the fuel gauge 100 which can exactly detect the level of the liquid surface 91a.

Furthermore, in the above embodiment in which the main body portion 21 made of the insulating resin material and the electrically conductive member 25 made of the conducting resin material are integrally formed with each other by the two-stage molding method, it may happen that the main body portion 21 and the electrically conductive member 25 can not be sufficiently fixed to each other. According to the present embodiment, therefore, the multiple supporting ribs 22 are formed to support the tubular portion 26. As a result, even if the tubular portion 26 can not be sufficiently fixed to the main body portion 21 made of the insulating POM resin, the tubular portion 26 is hardly inclined with respect to the main body portion 21. As above, even when a force is applied to the tubular portion 26 from the float arm 50, the tubular portion 26 can surely and rotatably support the float arm 50. Since the rotational angle of the float arm 50 can exactly correspond to the level of the liquid surface 91a of the fuel 91, the detecting circuit 40a can exactly detect the liquid surface level.

As a result that the function of the supporting ribs 22 for realizing the exact operation of the float arm 50 is carried out together with the function of the electrically conductive member 25 for moving the electric charge from the float arm 50 to the ground terminal 76, the accuracy for detecting the liquid surface level by the fuel gauge can be further increased.

### Second Embodiment

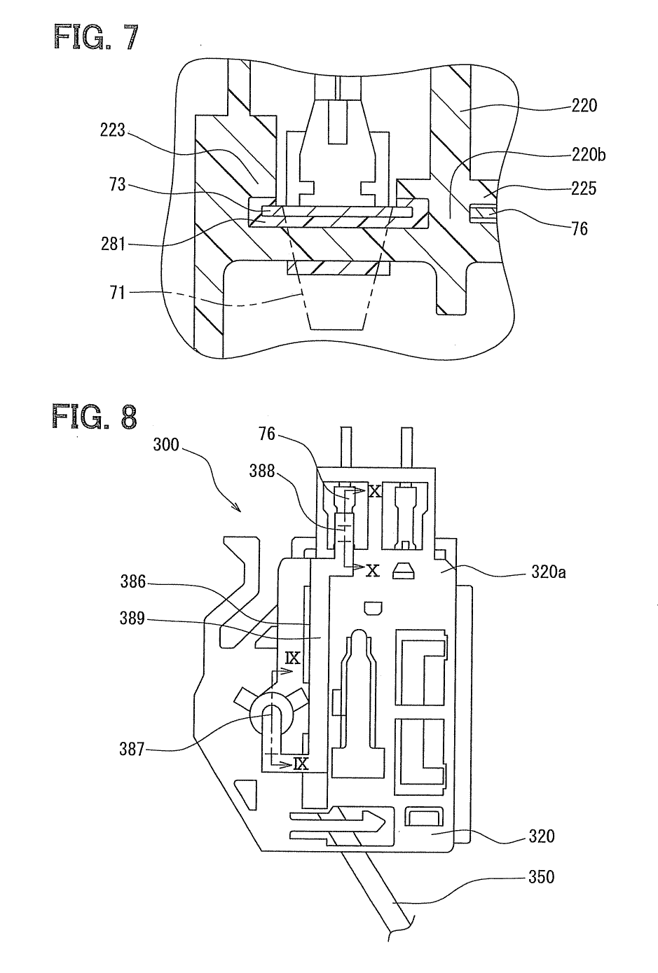

A second embodiment of the present invention shown in FIGS. 1, 6 and 7 is a modification of the first embodiment. A fuel gauge 200 of the second embodiment has a housing 220, a shape of which is substantially the same to that of the housing 20 of the first embodiment. An entire portion of the housing 220 is made of the conducting resin material, such as the POM resin including the carbon. According to such a feature, the housing 220 has an electrically conductive portion 225 for electrically connecting the float arm 50 to the ground terminal 76. As above, even in the case that the housing has the electrically conductive portion 225, the number of parts and components for the fuel gauge 200 can be reduced.

If the positive terminal 71 is directly fixed to the housing 220 in the case that the entire portion of the housing 220 is formed of the conducting resin material, electric current may flow between the positive terminal 71 and the ground terminal 76 via the housing 220. Then, the electric resistance value of the variable resister 41 may not be correctly outputted from the detecting circuit 40a.

According to the second embodiment, therefore, the fuel gauge 200 has an insulating member 281. The insulating member 281 is made of, for example, the insulating resin material. The insulating member 281 is formed, in an inflected shape, wherein a plate-formed portion of the insulating member 281 is bent along a shape of a side wall 220b forming a press-fit portion 223. In other words, the insulating member 281 has a pouched shape covering the side wall 220b. The insulating member 281 is press-inserted into the press-fit portion 223. The press-insert portion 73 of the positive terminal 71 is press-inserted into the press-fit portion 223, so that the insulating member 281 is interposed between an inner wall surface of the press-fit portion 223 and the press-insert portion 73. As above, the insulating member 281 is attached to the housing 220 and holds the positive terminal 71 so that the positive terminal 71 and the housing 220 are insulated from each other.

As explained above, according to the present embodiment, the insulating member 281 is arranged between the positive terminal 71 and the housing 220, so that the positive terminal 71 and the housing 220 are surely insulated from each other. According to such a structure, the electric current is prevented from flowing between the positive terminal 71 and the ground terminal 76 via the housing 220. Since the exact value of the electric resistance of the variable resister 41 can be thereby outputted from the detecting circuit 40a, the fuel gauge 200 can exactly detect the level of the liquid surface 91a.

### Third Embodiment

A third embodiment of the present invention shown in FIGS. 8 to 10 is another modification of the first embodiment. A fuel gauge 300 of the third embodiment has a housing 320 corresponding to the housing 20 of the first embodiment (FIG. 3). An entire portion of the housing 320 is made of the insulating resin material, such as the POM resin. In addition, the housing 320 has a terminal member 386 made of conducting material, so that a float arm 350 is electrically connected to the ground terminal 76. The terminal member 386 is also referred to as the electrically conductive portion. Characterizing portions of the fuel gauge 300 of the third embodiment will be further explained below.

The terminal member 386 is made of metal material and formed in a plate shape. The terminal member 386 has an arm-contacting portion 387, a terminal-contacting portion 388 and a terminal main body 389. The arm-contacting portion 387 is in contact with an end surface 351a of a rotational shaft 351 of the float arm 350. The arm-contacting portion 387 is biased to the end surface 351a of the float arm 350 by elastic force of the terminal member 386 in an axial direction of the rotational shaft 351. The terminal-contacting portion 388 is in contact with the ground terminal 76. The terminal-contacting portion 388 is biased to a back side of the ground terminal 76 by the elastic force of the terminal member 386. The terminal main body 389 connects the arm-contacting portion 387 and the terminal-contacting portion 388 with each other. The terminal main body 389 extends along a bottom wall 320a of the housing 320. The terminal main body 389 is attached to the housing 320 by multiple claw portions (not shown) formed on the bottom wall 320a of the housing 320.

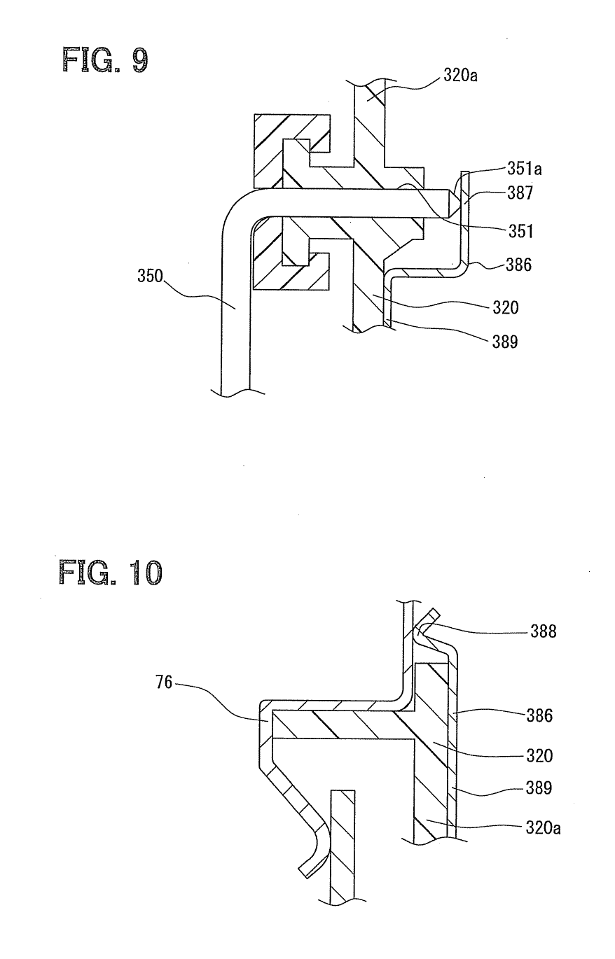

As shown in FIG. 9, the end surface 351a is extending toward the arm-contacting portion 387 in the axial direction of the rotational shaft 351. A contacting area between the end surface 351a of the float arm 350 and the arm-contacting portion 387 of the terminal member 386 is reduced.

As explained above for the present embodiment, the electrical connection between the float arm 350 and the ground terminal 76 can be realized by the terminal member 386, which is a separate part from the housing 320. According to the above structure, the terminal member 386 is made of the metal material and thereby the arm-contacting portion 387 can be surely brought into contact with the float arm 350 by use of high elasticity belonging to the metal material. In the similar manner, the terminal-contacting portion 388 of the terminal member 386 can be surely brought into contact with the ground terminal 76 by use of the high elasticity belonging to the metal material. As above, the electrical connection (the electrical contact) between the terminal member 386 and the ground terminal 76 as well as the electrical connection between the terminal member 386 and the float arm 350 can be surely realized. Accordingly, the electric charge generated in the float 60 (FIG. 1A) can be surely discharged to the ground terminal 76 via the float arm 350 and the terminal member 386.

In addition, according to the present embodiment, the arm-contacting portion 387 is biased to the end surface 351a of the rotational shaft 351 in the axial direction thereof, wherein the end surface 351a of the rotational shaft 351 is not moved even when the float arm 350 is rotated. Therefore, the terminal member 386 can continuously and surely keep the contact (the electrical connection) between the arm-contacting portion 387 and the float arm 350. As above, since the electrical connection between the terminal member 386 and the float arm 350 is surely maintained, the electric charge generated at the float 60 (FIG. 1A) can be surely discharged to the ground terminal 76 via the float arm 350 and the terminal member 386.

Accordingly, the fuel gauge 300 of the third embodiment can exactly detect the level of the liquid surface 91a (FIG. 1A) without being affected by the electric charge.

In addition, according to the present embodiment, since the contacting area between the end surface 351a of the float arm 350 and the arm-contacting portion 387 of the terminal member 386 is reduced, the rotation of the float arm 350 may be hardly affected by the arm-contacting portion 387, which is biased to and in contact with the rotational shaft 351. The fuel gauge 300 can, therefore, exactly detect the level of the liquid surface 91a by the rotational displacement of the float arm 350, which surely follows the change of the level of the liquid surface 91a (FIG. 1A).

### Fourth & Fifth Embodiments

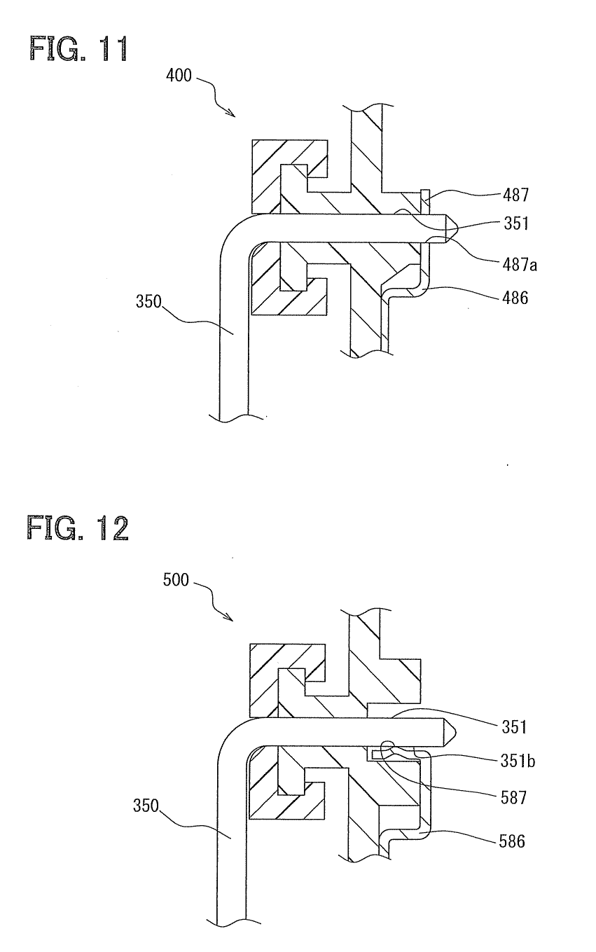

A fourth embodiment of the present invention shown in FIG. 11 and a fifth embodiment of the present invention shown in FIG. 12 are respectively modifications of the third embodiment.

A fuel gauge 400 (FIG. 11) has a terminal member 486 corresponding to the terminal member 386 of the third embodiment (FIG. 8). An arm-contacting portion 487 of the terminal member 486 has a bearing hole 487a, an inner diameter of which is slightly smaller than an outer diameter of the rotational shaft 351 of the float arm 350. According to the above structure, the rotational shaft 351 is rotated relative to the arm-contacting portion 487, in other words, the rotational shaft 351 slides with respect to the bearing hole 487a, when the float arm 350 is moved depending on the level of the liquid surface 91a (FIG. 1A).

A fuel gauge 500 (FIG. 12) has a terminal member 586 corresponding to the terminal member 386 of the third embodiment (FIG. 8). An arm-contacting portion 587 of the terminal member 586 is in contact with a side surface 351b of the rotational shaft 351. The arm-contacting portion 587 is biased to the side surface 351b of the float arm 350 in a radial direction of the rotational shaft 351 by elasticity belonging to the terminal member 586.

Even according to the fourth and fifth embodiments, each of the terminal members 486 and 586 (also referred to as the electrically conductive portion) can continuously and surely keep the contact (the electrical connection) between the arm-contacting portion 487/587 and the float arm 350. As above, since the electrical connection between the terminal member 486/586 and the float arm 350 is surely maintained, the electric charge generated at the float 60 (FIG. 1A) can be surely discharged to the ground terminal 76 via the float arm 350 and the terminal member 486/586. The contact (the electrical connection) at the respective contacting points between the arm-contacting portion 487/587 and the float arm 350 is surely maintained. Therefore, the fuel gauge 400/500 can exactly detect the level of the liquid surface 91a (FIG. 1A) without being affected by the electric charge.

### Sixth Embodiment

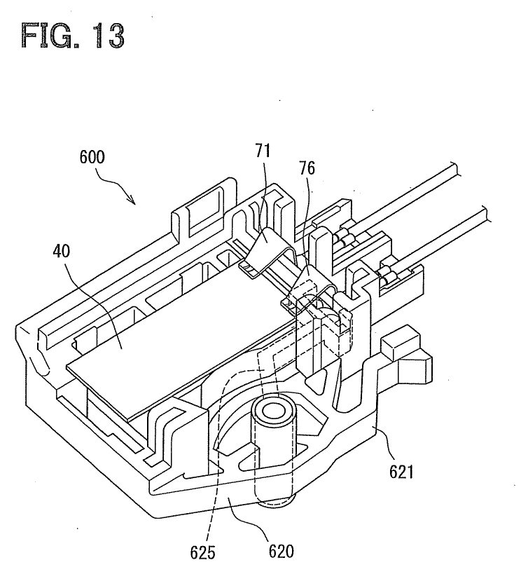

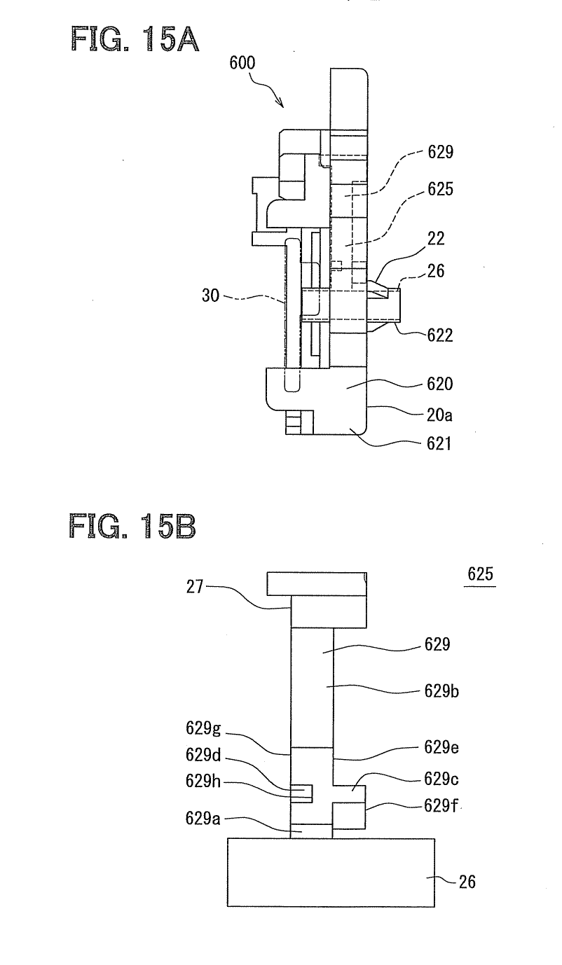

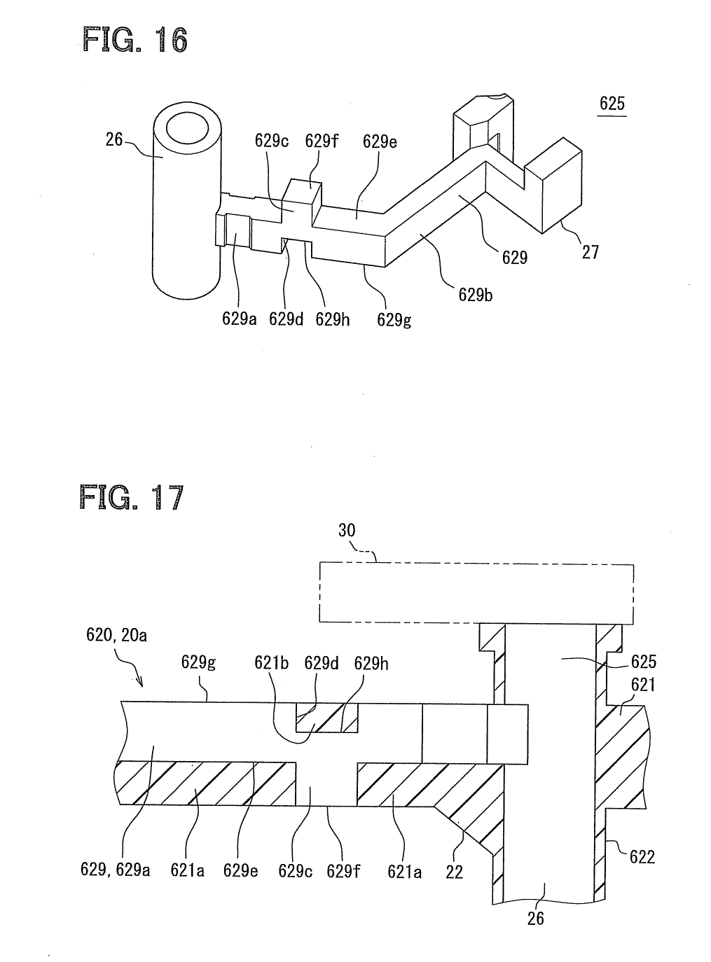

A sixth embodiment of the present invention shown in FIGS. 13 to 17 is a further modification of the first embodiment. A housing 620 of a fuel gauge 600 of the sixth embodiment accommodates the printed circuit board 40, as in the same manner to the housing 20 of the first embodiment (FIG. 1A), to which the positive terminal 71 and the ground terminal 76 are fixed and connected. According to the housing 620, a main body portion 621 made of insulating material houses therein an electrically conductive member 625. The housing 620 having the main body portion 621 and the electrically conductive member 625 is made by the two-stage molding method.

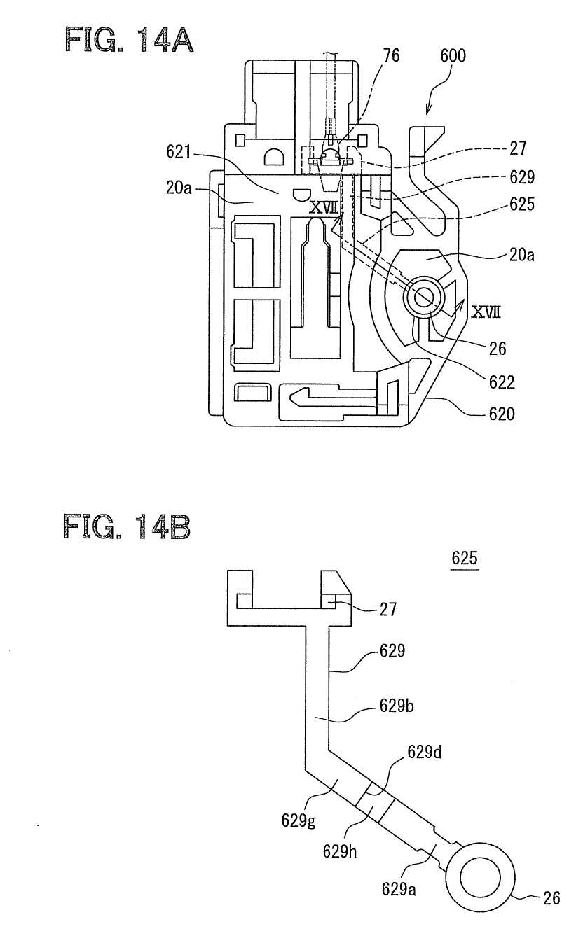

As shown in FIGS. 14 to 17, the electrically conductive member 625 (hereinafter also referred to as the electrically conductive portion 625) has the tubular portion 26 and the press-fit portion 27 (each of which is substantially the same to the tubular portion 26 and the press-fit portion 27 of the first embodiment) and a connecting portion 629 (which corresponds to the connecting portion 29 of the first embodiment). The tubular portion 26 is located at the bottom wall 20a for rotatably supporting the rotational shaft 51 of the float arm 50. The ground terminal 76 is press-inserted into the press-fit portion 27 and thereby the ground terminal 76 is fixed to the housing 620.

The connecting portion 629 is integrally formed with (i.e. embedded in) the bottom wall 20a of the housing 620 and electrically connects the tubular portion 26 and the press-fit portion 27 with each other. The connecting portion 629 is composed of a first extending portion 629a, a second extending portion 629b and so on. The first extending portion 629a extends from an outer periphery of the tubular portion 26. The second extending portion 629b extends from the first extending portion 629a to the press-fit portion 27, wherein the second extending portion 629b is bent with respect to the first extending portion 629a.

A projected portion 629c and a recessed portion 629d are formed in the first extending portion 629a. The projected portion 629c is projected from a side surface 629e, which is formed on a side of the first extending portion 629a opposite to the arm holder 30, in a direction opposite to the arm holder 30. The projected portion 629c is formed in a shape of a rectangular solid. A top surface 629f of the projected portion 629c is exposed from a housing surface after the electrically conductive member 625 is formed (molded) in the housing 620, wherein the housing surface is located at a side of the bottom wall 20a opposite to the arm holder 30. The recessed portion 629d is formed in the first extending portion 629a in such a manner that a portion of a side surface 629g opposite to the side surface 629e is recessed toward the projected portion 629c. The recessed portion 629d is aligned with the projected portion 629c in a direction parallel to an axial direction of the tubular portion 26. The side surface 629g, on which the recessed portion 629d is formed, is exposed toward the arm holder 30, after the electrically conductive member 625 is formed (molded) in the housing 620.

The main body portion 621 has a surrounding wall 622 in addition to the supporting ribs 22, which are substantially the same to those of the first embodiment. The main body portion 621 forms the bottom wall 20a of the housing 620. The surrounding wall 622 is formed in a cylindrical shape entirely surrounding an outer circumferential periphery of the tubular portion 26. In addition, the surrounding wall 622 covers the outer circumferential periphery of the tubular portion 26 along its axial direction. Outer portions of the surrounding wall 622, which surrounds the tubular portion 26, are supported by the supporting ribs 22 to the bottom wall 20a.

The electrically conductive member 625 is embedded in the bottom wall 20a. A first supporting wall 621a and a second supporting wall 621b are formed in the bottom wall 20a (FIG. 17). The first supporting wall 621a is formed along an extending direction of the first extending portion 629a and aligned with the projected portion 629c. The first supporting wall 621a supports the side surface 629e of the connecting portion 629 in the axial direction of the tubular portion 26 toward the arm holder 30. The second supporting wall 621b is formed so as to supplement the recessed portion 629d. The second supporting wall 621b supports a bottom surface 629h of the recessed portion 629d in a direction opposite to the first supporting wall 621a, namely from a side of the housing 620. As above, the bottom wall 20a supports the connecting portion 629 from the both sides thereof in a thickness direction of the bottom wall 20a, that is, in the axial direction of the tubular portion 26. The connecting portion 629 is thus held by the bottom wall 20a.

According to the above structure of the housing 620, in which the main body portion 621 and the electrically conductive member 625 are integrally formed with each other by the two-stage molding method, it may happen that the main body portion 621 and the electrically conductive member 625 can not be sufficiently fixed to each other. According to the present embodiment, therefore, not only the surrounding wall 622 supports the tubular portion 26 but also the first and second supporting walls 621a and 621b hold the connecting portion 629. According to such a structure, even if the two parts (the housing 620 and the member 625) made of different resin materials can not be sufficiently fixed to each other, the tubular portion 26 is hardly inclined with respect to the main body portion 621 and the tubular portion 26 is hardly displaced with respect to the main body portion 621 in the axial direction. As above, even when a force is applied to the tubular portion 26 from the float arm 50, the tubular portion 26 can surely and rotatably support the float arm 50. Since the rotational angle of the float arm 50 can exactly correspond to the level of the liquid surface 91a of the fuel 91, the detecting circuit 40a can exactly detect the liquid surface level.

According to the present embodiment, the function of the surrounding wall 622 for surely realizing the operation of the float arm 50 is carried out together with the function of the electrically conductive member 625 for moving the electric charge from the float arm 50 to the ground terminal 76. As a result, the accuracy for detecting the liquid surface level by the fuel gauge 600 can be further increased.

In addition, according to the present embodiment, the surrounding wall 622 surrounds the entire outer periphery of the tubular portion 26 not only in the circumferential direction but also in the axial direction. Therefore, the tubular portion 26 can be more firmly supported by the surrounding wall 622. As above, since the float arm 50 is more accurately supported by the tubular portion 26, the rotational angle of the float arm 50 more exactly corresponds to the level of the liquid surface 91a of the fuel. Accordingly, the surrounding wall 622 surrounding the tubular portion 26 contributes to increase the accuracy for detecting the level of the liquid surface 91a by the fuel gauge 600.

### Other Embodiments

Although the multiple embodiments of the present invention are explained as above, the present invention should not be limited to those embodiments. The present invention can be further modified in various manners without departing from the spirit of the invention and the above embodiments can be combined to each other.

According to the first embodiment, the housing 20 having the main body portion 21 made of the insulating material and the electrically conductive member 25 made of the conducting material is made by the two-stage molding method. The main body portion 21 and the electrically conductive member 25 may not be always integrally formed as one unit. For example, the electrically conductive portion made of the conducting resin material may be assembled to the main body portion made of the insulating resin material, to thereby form the housing.

According to the first embodiment, the bearing surface 26b and the press-fit portion 27 are provided in the electrically conductive member 25 so as to form the electrical connections between the electrically conductive member 25 and the float arm 50 and between the electrically conductive member 25 and the ground terminal 76. However, only a part of the bearing surface 26b may be provided in the electrically conductive member 25, so long as the electrical connection between the electrically conductive member and the float arm 50 can be maintained. In a similar way, only a part of the press-fit portion 27 may be provided in the electrically conductive member 25, so long as the electrical connection between the electrically conductive member and the ground terminal 76 can be maintained. In addition, the bearing surface and the press-fit portion 27 may be provided in the main body portion made of the insulating material, in a case that the electrical connection between the float arm 50 and the ground terminal 76 is realized by a terminal member, which is formed as a separate member from the housing.

According to the first embodiment, the value of the electric resistance of the electrically conductive member 25 provided between the float arm 50 and the ground terminal 76 is made to be smaller than 1 megohm (M). The value of the electric resistance of the electrically conductive member 25 should not be limited to the above value. When the electrically conductive member 25 is made of metal, the value of the electric resistance can be made much smaller. The value of the electric resistance of the electrically conductive member can be decided in consideration of the electric charge to be accumulated in the float and/or the float arm, the resistance properties of the detecting circuit to the noises and so on.

According to the third to fifth embodiments, the terminal member (386, 486, 586) is made of the metal. The terminal member may be made of conducting resin material, when electrical conductivity required for the electrically conductive portion is smaller than 1 megohm (MD).

According to the sixth embodiment, the projected portion 629c is formed on the side surface 629e of the first extending portion 629a, while the recessed portion 629d is formed on the opposite side surface 629g. According to such a structure, the first supporting wall 621a and the second supporting wall 621b are alternately arranged in the bottom wall 20a of the housing 620 in the extending direction of the first extending portion 629a. The structure of the first and second supporting walls should not be limited to the above structure. For example, the first supporting wall may entirely cover the side surface 629e, while the second supporting wall may entirely cover the opposite side surface 629g. According to such a modified structure, the bottom wall 20a is formed in a three-layered structure, in which the conducting resin material (the connecting portion 629) is sandwiched by the insulating resin material at both sides (the first and second supporting walls 621a and 621b). Furthermore, the projected portion and the recessed portion may be eliminated from the side surfaces. Furthermore, multiple projected portions and multiple recessed portions may be formed in the connecting portion and the first and second supporting walls may be formed in the main body portion so as to supplement the projected and recessed portions. According to the sixth embodiment (FIG. 17), the first supporting wall 621a supports the connecting portion 629 in the direction toward the arm holder 30. However, the first supporting wall may support the connecting portion in the opposite direction to that of the sixth embodiment.

The present invention are explained based on the several embodiments, in which the invention is applied to the fuel gauge for detecting the level of the liquid surface 91a of the fuel 91 stored in the fuel tank 90 of the vehicle. The present invention should not be limited to the fuel gauge for detecting the liquid surface level of the fuel. The present invention may be applied to a detecting system for a liquid surface level of other liquid used in the vehicle, for example, brake fluid, engine cooling water, engine oil and so on. Furthermore, the present invention may be applied to a liquid level detecting system not only for the vehicle but also for transportation facilities, household apparatuses and so on.

What is claimed is:

1. A liquid level detecting device for detecting a level of liquid surface of liquid stored in a container comprising:
a stationary member fixed to the container;
a rotating member rotatably supported by the stationary member;
a float floating on the liquid surface of the liquid;
a float arm, one end of which holds the float and the other end of which is rotatably supported by the stationary member, the float arm having conducting properties and converting a vertical movement of the float into a rotational movement of the rotating member;
a detecting portion fixed to the stationary member and having a variable resister, a value of electric resistance of which varies depending on a rotational angle of the rotating member, the detecting portion detecting the level of the liquid surface based on the value of electric resistance of the variable resister;
a ground terminal for electrically connecting the detecting portion to an outside of the liquid level detecting device so that the detecting portion is grounded; and
an electrically conductive portion for electrically connecting the float arm to the ground terminal.

2. The liquid level detecting device according to the claim 1, wherein
the stationary member is composed of;
a main body portion made of insulating resin material; and
the electrically conductive portion made of conducting resin material,
wherein the electrically conductive portion is integrally formed with the main body portion.

3. The liquid level detecting device according to the claim 2, wherein
the electrically conductive portion has a bearing portion for rotatably supporting the other end of the float arm.

4. The liquid level detecting device according to the claim 3, wherein
the stationary member has a bottom wall formed by the main body portion,
the bearing portion is provided in the bottom wall and formed in a tubular shape, and
the main body portion has supporting ribs projecting from the bottom wall in an axial direction of the bearing portion in order to support the bearing portion from its outer periphery.

5. The liquid level detecting device according to the claim 4, wherein
the supporting ribs are arranged at the outer periphery of the bearing portion in its circumferential direction.

6. The liquid level detecting device according to the claim 2, wherein
the electrically conductive portion has a press-fit portion, wherein the ground terminal is press-inserted into the press-fit portion so that the ground terminal is fixed to the stationary member.

7. The liquid level detecting device according to the claim 6, wherein
the stationary member has a bottom wall formed by the main body portion,
the electrically conductive portion has a bearing portion provided in the bottom wall for rotatably supporting the other end of the float arm,
the electrically conductive portion has a connecting portion integrally formed with the bottom wall and electrically connecting the bearing portion to the press-fit portion,
the bottom wall has a first supporting wall for supporting the connecting portion in a first direction along an axial direction of the bearing portion, and
the bottom wall has a second supporting wall for supporting the connecting portion in a second direction opposite to the first direction.

8. The liquid level detecting device according to the claim 1, wherein
the stationary member has the electrically conductive portion made of conducting resin material,
a positive terminal for electrically connecting the detecting portion to the outside of the liquid level detecting device, in order to supply electric voltage to the detecting portion so that the electric voltage is applied to the variable resister,
an insulating member attached to the stationary member for holding the positive terminal so as to insulate the positive terminal from the stationary member.

9. The liquid level detecting device according to the claim 8, wherein
the electrically conductive portion has a bearing portion for rotatably supporting the other end of the float arm.

10. The liquid level detecting device according to the claim 8, wherein
the electrically conductive portion has a press-fit portion, wherein the ground terminal is press-inserted into the press-fit portion so that the ground terminal is fixed to the stationary member.

11. The liquid level detecting device according to the claim 1, wherein
the electrically conductive portion is made of metal, and
the electrically conductive portion has an arm-contacting portion which is in contact with the float arm and a terminal-contacting portion which is in contact with the ground terminal.

12. The liquid level detecting device according to the claim 11, wherein
the arm-contacting portion is biased to an end surface of the other end of the float arm in an axial direction of the other end of the float arm.
